(19) United States
(12) Patent Application Publication
(10) Pub. No.: US 2022/0372293 A1
(43) Pub. Date: Nov. 24, 2022

(54) SELF-HEALING COMPOSITIONS FOR USE IN MEDICAL TRAINING SIMULATORS AND MANNEQUINS

(71) Applicants: Sumitra RAJAGOPALAN, Montreal (CA); Maksym KRYUCHKOV, Pointe-Claire (CA); Nicholas COTTENYE, Montreal (CA); Jean-Richard BULLET, Montreal (CA)

(72) Inventors: Sumitra RAJAGOPALAN, Montreal (CA); Maksym KRYUCHKOV, Pointe-Claire (CA); Nicholas COTTENYE, Montreal (CA); Jean-Richard BULLET, Montreal (CA)

(21) Appl. No.: 17/770,875

(22) PCT Filed: Oct. 21, 2020
(86) PCT No.: PCT/CA2020/051410

§ 371 Date: Apr. 21, 2022

Related U.S. Application Data
(60) Provisional application No. 62/924,106, filed on Oct. 21, 2019.

(51) Int. Cl. C08L 83/08; C08G 77/26; C08J 5/18

(52) U.S. Cl. CPC C08L 83/08; C08G 77/26; C08J 5/18; C08L 2203/02; C08L 2203/16

(57) ABSTRACT

There are provided self-healing elastomeric materials and compositions and skin-like materials for use in a wide range of applications, particularly medical training simulators and mannequins. The self-healing elastomeric material comprises polysiloxane or poly ether soft segments connected via carbonate, urethane and/or urea bonds. The self-healing elastomeric material is intrinsically and/or thermally self- healing. Reusable devices, apparatuses and articles comprising the elastomeric materials as skin-like materials are disclosed.

### CROSS-REFERENCE TO RELATED APPLICATIONS

This application claims the benefit of priority from U.S. Provisional Application No. 62/924,106, filed Oct. 21, 2019, the entire contents of which are hereby incorporated by reference.

### FIELD

The disclosure relates generally to self-healing elastomeric materials and compositions for use in medical training simulators and mannequins, methods of preparation, and reusable medical training simulators and mannequins having self-healing properties.

### BACKGROUND

The ability to spontaneously heal injury is a key biomaterial feature that increases the survivability and lifetime of most plants and animals. In sharp contrast, synthetic materials usually fail after damage or fracture. Scientists and engineers have long dreamed of developing self-healing materials to improve the safety, lifetime, energy efficiency and environmental impact of synthetic materials. However, most approaches to self-healing materials require the input of external energy, healing agents, solvents or plasticizers. Despite intense research in this area, the provision of materials with spontaneous self-healing abilities remains a challenge.

Elastomeric materials are widely used in the medical field to replicate human skin for training future doctors, surgeons and nurses in the art of injections, suturing, and knot-tying, as well as specialised techniques such as anastomosis, resections and others. However current skin-like materials, while they replicate the texture, colour and feel of real skin to varying degrees, suffer from an inability to be reused, once they have been used for training initially. For example, cutting and suturing leave behind jabs, cuts and gashes that render future use impossible. The single-use nature of current materials is severely limiting.

The development of polymers that can spontaneously repair themselves after mechanical damage would significantly improve the reusability of such materials, as well as potentially impact the safety, lifetime, energy efficiency and/or environmental impact of a wide range of synthetic materials.

U.S. Patent Application Publication No. 2014/0045161 describes a high-fidelity three-dimensional surgical training model for demonstrating or practicing surgical techniques. The three-dimensional surgical training model simulates human tissues of the head, neck and shoulders. The three-dimensional surgical training model may comprise a wide variety of defects, including but not limited to various cutaneous defects. The disclosure also relates to methods of building and utilizing a three-dimensional surgical training model.

U.S. Patent Application Publication No. 2019/0106544 describes stretchable, tough and autonomous self-healing elastomers and applications thereof. Elastomer materials comprising a flexible polymer backbone with a particular ratio of at least first moieties and second moieties are provided. The elastomer materials form a polymer film that exhibits autonomous self-healing in the presence of liquid, such as water or sweat.

Dabrowska et al., Skin Research and Technology 2016, vol. 22, pp. 3-14 describe materials used to simulate physical properties of human skin and characteristic properties of skin.

Jian et al., Polymer Advanced Technologies 2017, pp. 1-7 describe synthesis and characterization of a self-healing polyurethane material based on the combination of covalent disulfide bonds and non-covalent H-bonding.

Zhao et al., Polymer Chemistry 2016, DOI: 10.1039/C6PY01499B, describe self-healing poly(siloxane-urethane) elastomers with remoldability, shape memory and biocompatibility.

Wang et al., J. Mater. Chem. B, 2019, DOI: 10.1039/c9tb00831d, describe preparation, characterization and properties of intrinsic self-healing elastomers based on reversible covalent bonds and dynamic supramolecular chemistry, and potential applications therefor.

It is desirable to provide elastomeric materials, and devices and apparatuses thereof such as medical training simulators and mannequins, that can overcome the limitations of current materials.

### SUMMARY

The present disclosure relates generally to self-healing elastomeric materials for a wide range of applications, and methods of preparation therefor. More particularly, the present disclosure relates to self-healing elastomeric materials that can simulate skin and can be repaired after use, allowing repeated use of the materials in medical training simulators and mannequins. Elastomeric materials provided herein can not only replicate the texture, viscoelastic properties and/or feel of real skin, including the three layers of skin, fat and muscle, but in addition they can be repaired after use, either autonomously by bringing together the jagged ends of a cut or incision (intrinsic self-healing) or through thermal healing, e.g., by heating a cut and applying a gentle mechanical pressure (thermo self-healing). There are also provided elastomeric material compositions, and uses thereof, including multi-use medical training simulators and mannequins that have self-healing properties.

Self-healing elastomeric materials provided herein have application in a wide range of areas such as, without limitation, medical training simulators and mannequins. Suitable applications of the self-healing elastomeric materials may include, without limitation: a suture pad in an electric heated box; a reversible bleeding and healing skin; surgical simulators for training for cardiac and intestinal anastomosis; orthopedic surgical models for training in tendon and ligament repair; realistic healing brain models for training in neurosurgery; and the like. These models can be replicated through e.g. 3D-printing using intrinsic self-healing or thermo self-healing polymeric materials provided herein. Articles comprising the elastomeric materials of the present technology are generally reusable (can be used multiple times), due to the self-healing properties of the elastomeric materials that allow repair after each training session or use.

In a first aspect, there is provided a self-healing elastomeric material comprising, without limitation, polysiloxane soft segments connected via carbonate and/or urethane and/or urea bonds, wherein the self-healing elastomeric material is intrinsically and/or thermally self-healing. In an embodiment, the elastomeric material comprises about 80 wt % of soft segments such as polysiloxane. In an embodiment, the elastomeric material comprises about 90 wt % of soft segments such as polysiloxane. In some embodiments, the polysiloxane derivative is polydimethylsiloxane (PDMS). In some embodiments, the elastomeric material is thermally self-healing, and comprises thermoreversible disulphide bonds. In an embodiment, the elastomeric material comprises or is prepared from a mixture of polyurethane (PU) and a polysiloxane derivative, e.g., PDMS.

In a second aspect, there is provided a self-healing elastomeric material comprising, without limitation, polyether soft segments connected via carbonate and/or urethane and/or urea bonds, wherein the self-healing elastomeric material is intrinsically and/or thermally self-healing. In an embodiment, the elastomeric material comprises about 80 wt % of poly(propylene oxide) (PPO). In an embodiment, the elastomeric material comprises about 90 wt % of poly(propylene oxide) (PPO).

In some embodiments, elastomeric materials provided herein further comprise short hard segments formed by one or more of triethanolamine, 4,4′-dithiodianiline, a linear sulfide, 2-Hydroxyethyl disulfide (HEDS), 1,3-Propanediol bis-(4-aminobenzoate), hexamethylene diisocyanate (HMDI), isophorone diisocyanate (IPDI), HMDI oligomers (type urethdione and isocyanurate), methylene bis-diphenyldiisocyanate (MDI), dodecahydro methylene bis-diphenyldiisocyanate (MDI-H), bis-(isocyanato methylethylbenzene), and toluene diisocyanate (TDI).

In some embodiments, elastomeric materials provided herein comprise a cross-linker, such as without limitation isocyanurate or triethanolamine.

In some embodiments of elastomeric materials and compositions provided herein, the molecular weight of the soft segments of elastomeric material ranges from about 500 to about 30,000.

In some embodiments, the elastomeric material is capable of self-healing without requiring a liquid or solvent.

In some embodiments, the elastomeric material is self-healable due to thermoreversible disulphide bonds and/or hydrogen bonds.

In some embodiments, the elastomeric material is capable of self-healing at low to moderate temperature, at about 40° C. to about about 80° C., at less than about 80° C., or at room temperature.

In some embodiments, the elastomeric material is used to prepare an artificial skin or skin-like material. In some embodiments, a simulated skin provided herein has one or more of the following performance characteristics: instrinsic self-healing; thermal self-healing; tough; stretchable; transparent; high-fidelity; self-healing without requiring liquid (water, sweat, solvent, etc.); self-healing through chemical interactions (hydrogen bonding and/or thermoreversible disulfide bond re-formation or metathesis); realistic properties of human skin; substantially the same or similar tensile strength, elongation at break point, extension ratio, elasticity, Young's modulus, fracture strain and/or shape recovery ability as human skin.

In some embodiments, the elastomeric material is in the form of a film, e.g., a thin film.

In a third aspect, there is provided an artificial skin comprising the elastomeric material or composition of the present technology, and having properties substantially the same as or similar to those of human skin.

In an embodiment, there is provided a high-fidelity skin-simulating layer comprising: an epidermis-simulating layer, wherein the epidermis simulating layer comprises the elastomeric material of the present technology; an upper dermis-simulating layer disposed upon and adjacent to the epidermis-simulating layer, wherein the upper dermis-simulating layer comprises the self-healing elastomeric material of the present technology and/or a silicone rubber and/or a polysiloxane softener; a lower dermis-simulating layer disposed upon and adjacent to the upper dermis-simulating layer, wherein the lower dermis-simulating layer comprises a plurality of layers of the self-healing elastomeric material of the present technology and polyamide mesh; and a subcutaneous-simulating layer disposed upon and adjacent to the lower dermis-simulating layer, wherein the subcutaneous-simulating layer comprises a mixture of the self-healing elastomeric material of the present technology and/or a polysiloxane derivative and/or a polysiloxane softener.

In a fourth aspect, there are provided methods for fabricating elastomeric materials and compositions, and skin-like materials and apparatuses and articles thereof. In an embodiment, articles are fabricated using 3D printing. In some embodiments, there are provided methods of preparation that are solvent-free and/or use only minimal solvent.

In a fifth aspect, there are provided reusable devices, apparatuses and articles comprising the elastomeric materials and compositions and skin-like materials of the present technology. Such articles are generally reusable due to the self-healing properties of the materials of the present technology. In an embodiment, there are provided high-fidelity three-dimensional surgical training models comprising the elastomeric materials and simulated skin of the present technology. In some embodiments, there is provided a wearable item, an electronic device, a medical training simulator, a mannequin, a suture pad in an electric heated box, a reversible bleeding and healing skin, a surgical simulator for training for cardiac or intestinal anastomosis, an orthopedic surgical model for training in tendon or ligament repair, an artificial muscle, or a realistic healing brain model for training in neurosurgery.

In some embodiments, materials and compositions provided herein, as well as articles thereof, further comprise or are combined with an electroactive polymeric actuator, generator, sensor, or other energy transducer.

In some embodiments, materials and compositions provided herein, as well as articles thereof, further comprise or are combined with an electrochromic material that confers the ability to change color in response to certain manipulations or stimuli.

In a sixth aspect, there are provided methods of training medical practitioners, comprising providing a reusable, self-healing three dimensional surgical training model and performing surgical techniques upon the three-dimensional surgical training model.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the invention and to show more clearly how it may be carried into effect, reference will now be made by way of example to the accompanying drawings, which illustrate aspects and features according to embodiments of the present invention, and in which:

FIG. 1 illustrates structures of components of a self-healing elastomeric material (MK-323) in accordance with certain embodiments of the present technology.

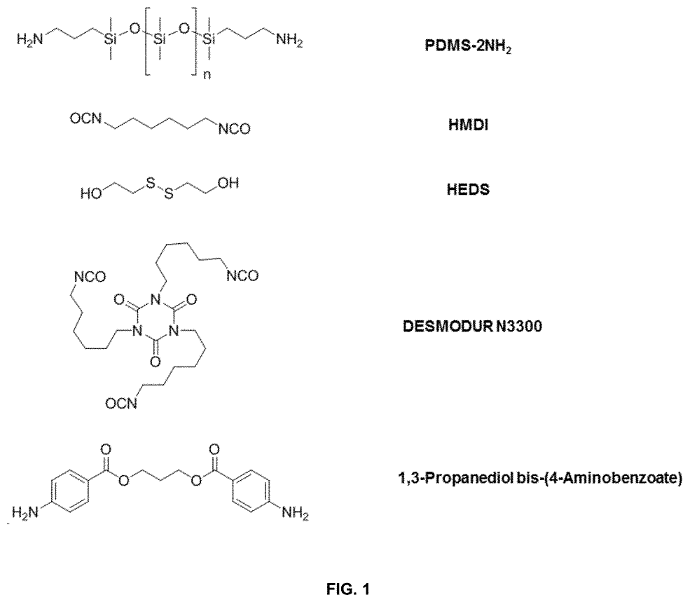

FIG. 2 illustrates structures of components of a self-healing elastomeric material (MK-326) in accordance with certain embodiments of the present technology.

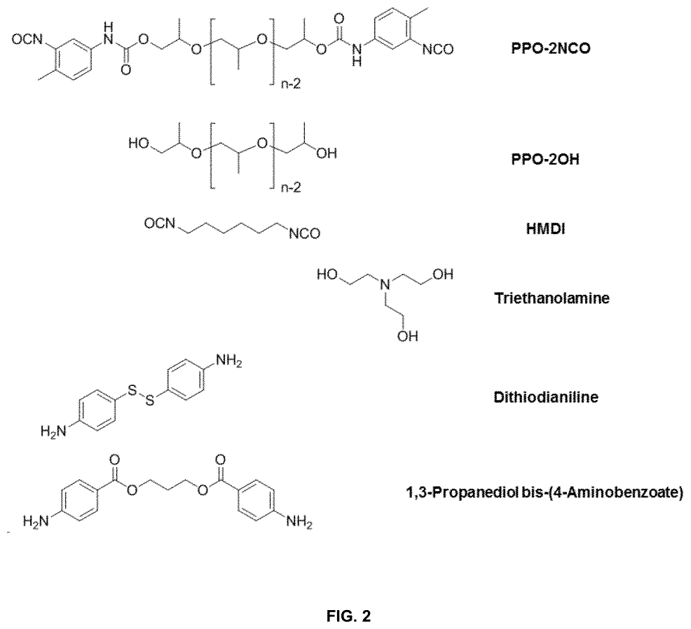

FIG. 3 illustrates structures of components of a self-healing elastomeric material (MK-332) in accordance with certain embodiments of the present technology.

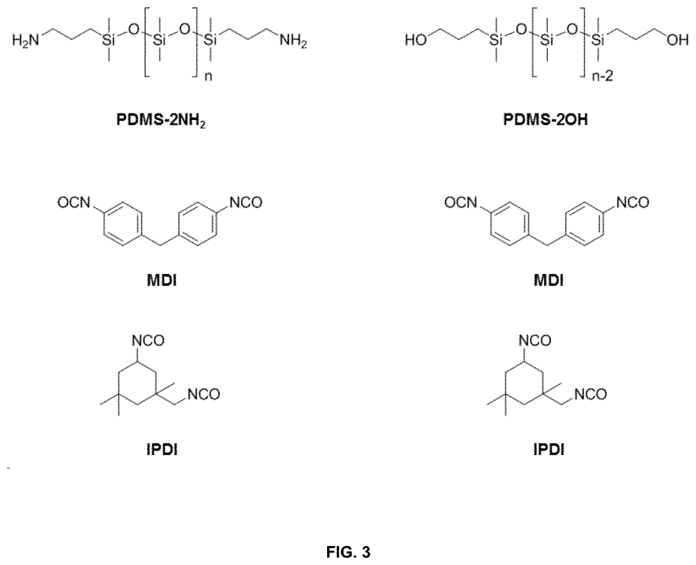

FIG. 4 is a photograph of a simulated heart organ for medical and surgical training in accordance with certain embodiments of the present technology.

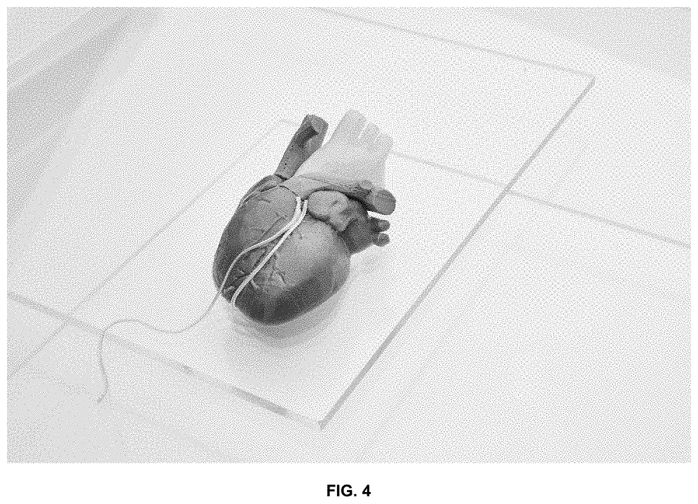

FIG. 5 is a photograph of a simulated skin shaped as a simulated limb for medical and surgical training in accordance with certain embodiments of the present technology.

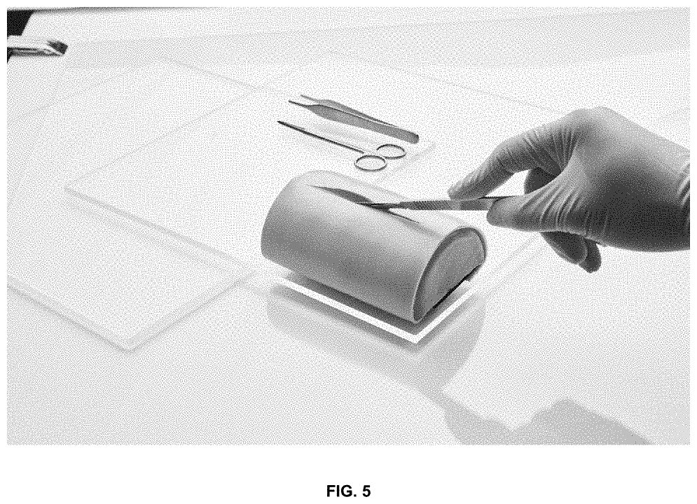

FIG. 6 is a photograph of simulated lips, where the lips on the left have turned blue to simulate cyanosis, in accordance with certain embodiments of the present technology.

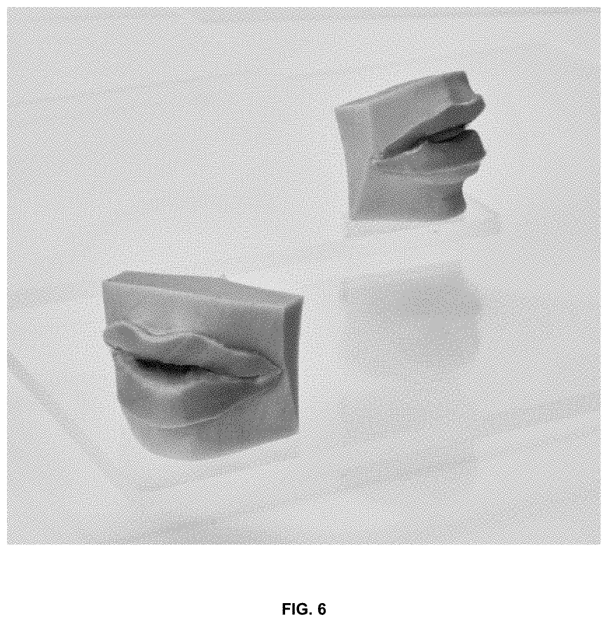

FIG. 7 is a photograph of simulated blood, in accordance with certain embodiments of the present technology.

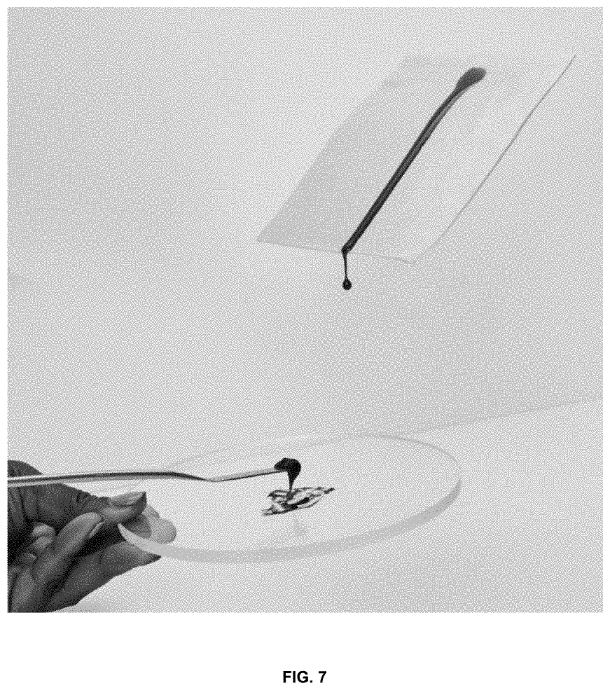

FIG. 8 is a photograph of a Smart Suture Box comprising a multilayer simulated skin construct with a built-in skin repair and healing module (in an electric heated box), in accordance with certain embodiments of the present technology.

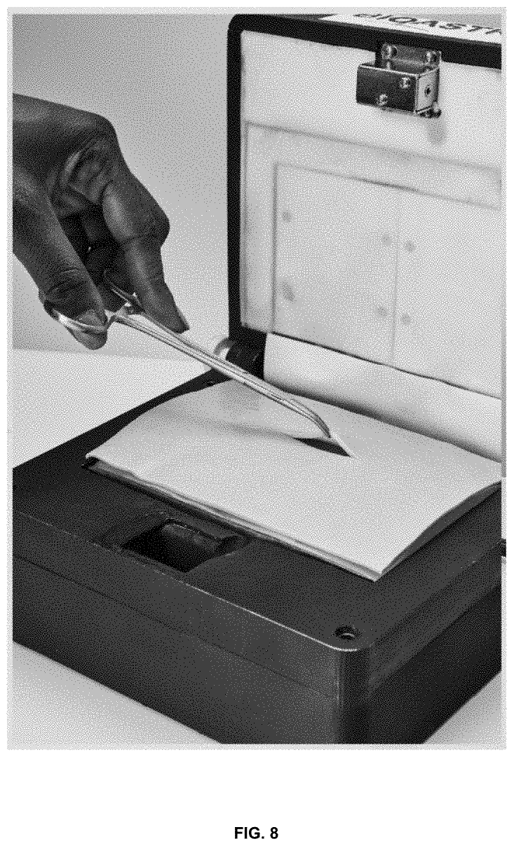

FIG. 9A is a photograph showing a model of a foot with simulated skin (yellow) attached.

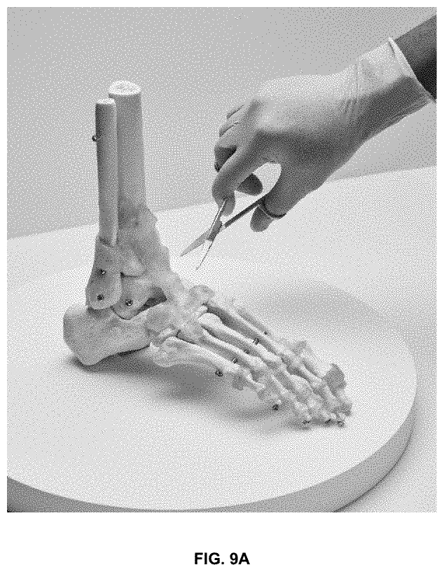

FIG. 9B is a photograph showing a magnified view of the simulated skin on the model seen in FIG. 9A, which is being cut.

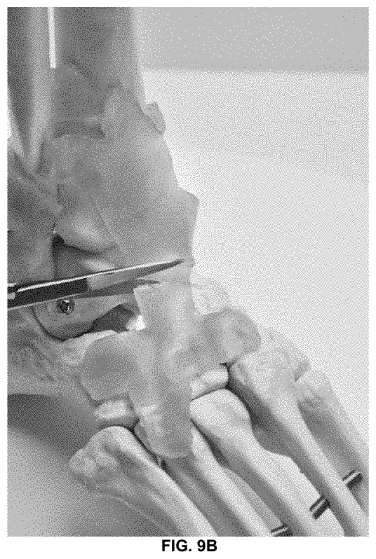

FIG. 9C is a photograph showing the simulated skin on the model seen in FIG. 9B after self-healing.

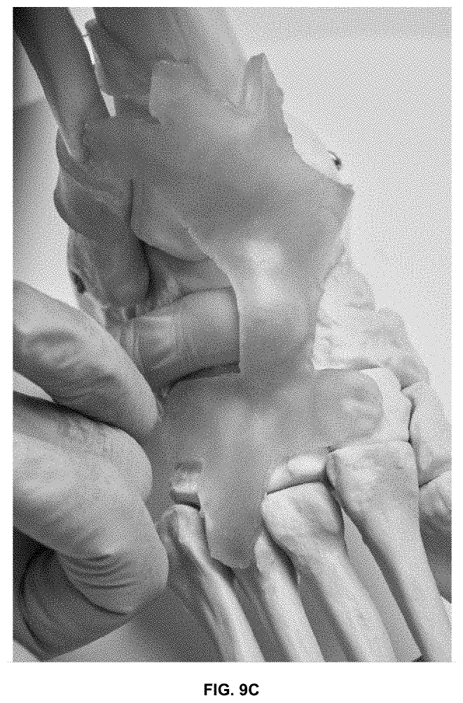

### DETAILED DESCRIPTION

The terminology used in the description of the various described embodiments herein is for the purpose of describing particular embodiments only and is not intended to be limiting.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this invention pertains.

### Definitions

As used herein, the use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) and “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

As used herein, an “elastomer” is a material that can be subjected to large deformations and can then return to its original state with little or no permanent deformation. The definition of elastomers comes from rubber which is generally defined as a material which can be highly stretched, and can retract rapidly and forcibly to maintain substantially its original dimensions on release of the force. An elastomer is generally a polymer with viscoelasticity (i.e., both viscosity and elasticity) and very weak intermolecular forces, and generally a lower Young's modulus and higher failure strain compared with other materials. Such materials typically are used to provide a region of flexibility to a system and may be subjected to repeated stresses during use. If a crack or tear is initiated during use, it can grow quickly. However, if a crack or tear is healed by the application of another polymer to the crack surface, this will often impair the mechanical properties or the surface of the material. Elastomers that can self-heal and maintain all or most of their advantageous elastomeric behavior, and other desirable properties, after they have self-healed are therefore preferable for many applications.

As used herein, the term “elastomeric material” is used to mean a material having the properties of an elastomer. In one embodiment, an elastomeric material is a polymeric material that can be strained to at least 100% without failing. Strain of a material is the change in a linear dimension divided by the original value of the linear dimension. A material has undergone failure under stress when the material is permanently deformed and/or can no longer perform its intended function. Examples of failure in polymeric materials include cracking, breaking, tearing, etc.

The term “self-healing” is used herein to refer to polymeric materials that can repair themselves after mechanical damage such as cracks, cuts, lesions, wounds, scars, and the like.

The term “intrinsic” self-healing is used herein to refer to self-healing that occurs autonomously and spontaneously without requiring the input of external energy in the form of heat or light, healing agents (monomers and catalysts), substantial solvation or plasticization. Intrinsic self-healing materials generally achieve repair through the inherent reversibility of chemical bonds and physical interactions between the damaged interfaces, for example, reversible covalent bonds, noncovalent bonds, etc.

The terms “thermo-” and “thermal” self-healing are used interchangeably herein to refer to self-healing that occurs at moderate or low temperature with heating and application of pressure, but without requiring additional energy, healing agents (monomers and catalysts), substantial solvation or plasticization.

As used herein, the terms “artificial skin” and “skin-like material” are used interchangeably to refer to a material that simulates human skin, i.e., that simulates the physical properties of human skin and generally has realistic or life-like skin-like properties.

As used herein, when content is indicated as being present on a “weight basis” or at a “weight percent (wt %)” or “by weight,” the content is measured as the percentage of the weight of component(s) indicated by dry basis (by taking moisture percentage in each component into account), relative to the total weight of all components present in a composition.

The term “derivative” as used herein, is understood as being a substance similar in structure to another compound but differing in some slight structural detail.

As used herein, the term “polymer” refers to a material that includes a set of macromolecules. Macromolecules included in a polymer can be the same or can differ from one another in some fashion. A macromolecule can have any of a variety of skeletal structures, and can include one or more types of monomeric units. In particular, a macromolecule can have a skeletal structure that is linear or non-linear. Examples of non-linear skeletal structures include branched skeletal structures, such those that are star branched, comb branched, or dendritic branched, and network skeletal structures. A macromolecule included in a homopolymer typically includes one type of monomeric unit, while a macromolecule included in a copolymer typically includes two or more types of monomeric units. Examples of copolymers include statistical copolymers, random copolymers, alternating copolymers, periodic copolymers, block copolymers, radial copolymers, and graft copolymers.

In some instances, a reactivity and a functionality of a polymer can be altered by addition of a set of functional groups, such as acid anhydride groups, amino groups and their salts, N-substituted amino groups, amide groups, carbonyl groups, carboxy groups and their salts, cyclohexyl epoxy groups, epoxy groups, glycidyl groups, hydroxy groups, isocyanate groups, urea groups, aldehyde groups, ester groups, ether groups, alkenyl groups, alkynyl groups, thiol groups, disulfide groups, silyl or silane groups, groups based on glyoxals, groups based on aziridines, groups based on active methylene compounds or other b-dicarbonyl compounds (e.g., 2,4-pentandione, malonic acid, acetylacetone, ethylacetone acetate, malonamide, acetoacetamide and its methyl analogues, ethyl acetoacetate, and isopropyl acetoacetate), halo groups, hydrides, or other polar or H bonding groups and combinations thereof. Such functional groups can be added at various places along the polymer, such as randomly or regularly dispersed along the polymer, at ends of the polymer, on the side, end or any position on the crystallizable side chains, attached as separate dangling side groups of the polymer, or attached directly to a backbone of the polymer. Also, a polymer can be capable of cross-linking, entanglement, or hydrogen bonding in order to increase its mechanical strength or its resistance to degradation under ambient or processing conditions.

“Polymerization” is a process of reacting monomer molecules together in a chemical reaction to form three-dimensional networks or polymer chains. Many forms of polymerization are known, and different systems exist to categorize them, as are known in the art.

As can be appreciated, a polymer can be provided in a variety of forms having different molecular weights, since a molecular weight (MVV) of the polymer can be dependent upon processing conditions used for forming the polymer. Accordingly, a polymer can be referred to as having a specific molecular weight or a range of molecular weights. As used herein with reference to a polymer, the term “molecular weight (MVV)” can refer to a number average molecular weight or a weight average molecular weight. Polymers are often referred to in terms of their average MW, for example PEG1000 refers to PEG of average MW of 1000. Polymers may also be referred to in terms of their degree of polymerization (“n”), which can range, generally, from as low as 40 to as high as 5000. In some cases, polymers of different molecular weights may be mixed to give a composition having desired properties. It should be understood that polymers of any molecular weight, or mixtures of polymers of different molecular weights, may be used, as long as the resulting composition has the desired properties or is generally suitable for the uses described herein, as will be determined by the skilled artisan using known techniques.

As used herein, the term “copolymer” refers to polymers having two or more different divalent monomer units.

As used herein, the term “chemical bond” refers to a coupling of two or more atoms based on an attractive interaction, such that those atoms can form a stable structure. Examples of chemical bonds include covalent bonds and ionic bonds. Other examples of chemical bonds include hydrogen bonds and attractive interactions between carboxy groups and amine groups. As used herein, the term “covalent bond” means a form of chemical bonding that is characterized by the sharing of pairs of electrons between atoms, or between atoms and other covalent bonds. Attraction-to-repulsion stability that forms between atoms when they share electrons is known as covalent bonding. Covalent bonding includes many kinds of interactions, including sigma-bonding, pi-bonding, metal-metal bonding, agostic interactions, and three-center two-electron bonds.

As used herein, the term “reactive function” means a chemical group (or a moiety) capable of reacting with another chemical group to form a covalent or an electrovalent bond, examples of which are given above. Preferably, such reaction is doable at relatively low temperatures, e.g. below 200° C., more preferably below 100° C., and/or at conditions suitable to handle delicate substrates, e.g. textiles. A reactive function could have various chemical natures. For example, a reactive function could be capable of reacting and forming electrovalent bonds or covalent bonds with reactive functions of various substrates, e.g., cotton, wool, fur, leather, polyester, or textiles made from such materials, as well as other base materials.

As used herein, the term “nanocrystalline filler” refers to a nanocrystalline material, e.g., a nanocrytalline particle or polymer, capable of providing mechanical reinforcement to a polymer by forming a nanocomposite material. In an embodiment, a nanocrystalline filler reinforces a polymer through non-covalent physical interactions such as, without limitation, hydrogen bonds or electrostatic attractions, and without attenuating or substantially adversely affecting other desired properties of the polymer (such as electroactivity).

### Elastomeric Materials and Compositions

There are provided self-healing elastomeric materials and compositions thereof that provide desirable performance characteristics such as elasticity (e.g., extension ratio, Young's modulus), self-healability (e.g., intrinsic or thermal self-healing), stretchability, toughness, softness, transparency, reusability (e.g., multi-use), and/or realistic or high fidelity skin-like properties. The self-healing elastomeric materials and compositions of the present technology are intrinsically or thermally self-healing, e.g., capable of self-healing without requiring a liquid or solvent, e.g., capable of self-healing autonomously without application of extraneous energy or chemicals, and/or capable of self-healing at low or moderate temperature upon heating and pressing.

In some embodiments, the elastomeric materials and compositions thereof provided herein have properties and performance characteristics substantially the same or similar to those of human skin. In some such embodiments, the elastomeric materials and compositions are capable of simulating skin and can be used to prepare an artificial skin or skin-like material.

In some embodiments, elastomeric materials and compositions thereof provided herein are skin-like, thermoplastic, and/or self-healing.

In some embodiments, the elastomeric materials and compositions thereof provide realistic or high-fidelity skin-like materials with multi-use capabilities, due to their self-healing properties.

In some embodiments, the elastomeric materials and compositions thereof are cross-linked physically and/or chemically. In some embodiments, the elastomeric materials and compositions thereof are cross-linked both physically and chemically. In some embodiments, the elastomeric materials and compositions thereof are cross-linked chemically and are intrinsically self-healing due to chemical interactions that occur between monomers (e.g., Hydrogen (H) bonding, disulfide linkages). In some embodiments, the elastomeric materials and compositions thereof are thermoplastic. In some embodiments, the elastomeric materials and compositions thereof can be self-healed at low or moderate temperature, e.g., at temperatures from about 40° C. to about 80° C., or at temperatures of less than about 80° C. In some embodiments, the elastomeric materials and compositions thereof can be self-healed at room temperature. In some embodiments, the elastomeric materials and compositions do not require the present of liquid (water, sweat, solvent, etc.) for self-healing to occur. This can also be advantageous from both an environmental and a cost perspective, e.g., reducing the amount of solvent used.

In some embodiments, self-healing elastomeric materials and compositions provided herein generally comprise a mixture of a thermoplastic elastomer such as polyurethane (PU) and another elastomer such as polydimethylsiloxane (PDMS).

In some embodiments, self-healing elastomeric materials and compositions provided herein comprise a thermoplastic polymer such as poly(propylene oxide) (PPO). In some embodiments, self-healing elastomeric materials and compositions provided herein comprise PU and PPO. In some embodiments, self-healing elastomeric materials and compositions provided herein comprise PU, PPO and a nanocrystalline filler such as NCC. In some embodiments, self-healing elastomeric materials and compositions provided herein comprise PU, PPO, NCC, dithiodianiline or a linear sulfide, and a cross-linker, such as isocyanurate or triethanolamine.

In one embodiment, there is provided a self-healing elastomeric material or composition or a skin-like material that is capable of thermal self-healing, the material comprising a polysiloxane derivative, e.g., PDMS, with thermoreversible disulphide bonds.

Polyurethane (PU) is a widely-used polymer material which can be made from simple polyaddition reaction of polyol, isocyanate, and a chain extender. It is a polymer composed of organic units joined by carbamate (urethane) links. Polyurethane polymers are traditionally and most commonly formed by the reaction between a di- or poly-isocyanate with a polyol. Both the isocyanates and polyols used to make polyurethanes contain, on average, two or more functional groups per molecule. While most of the PUs are thermosetting polymers that do not melt when heated below 200 degC due to the covalent chemical crosslink, thermoplastic polyurethanes are also available through physical crosslinking. Physically crosslinked PU consisting of alternating rigid and flexible blocks can be melted multiple times with enough energy input. For chemically crosslinked PU elastomers, self-healing properties can be obtained by incorporating dynamic bonds into the polyurethane network or a damage induced chemical reaction.

PDMS is a very common elastomer consisting of Si—O—Si units. Due to its unique structure, polysiloxane has the advantages of high and low temperature resistance, weather resistance, electrical insulation, ozone resistance, hydrophobicity, gas permeability, non-toxicity, bio-inertness and so on. It is widely used in the electronic, health care, aerospace, textile and other fields. However, the mechanical strength of common polysiloxane is not as good as polyurethane.

Without wishing to be limited to theory, it is believed that the combination of polyurethane chemistry and polysiloxane (e.g., PDMS) and/or polyether (e.g., PPO) can provide self-healing elastomeric materials having advantageous mechanical and thermal properties. Further, polysiloxanes provide very hydrophobic surfaces and are of low toxicity, making the materials good candidates for potential biomedical applications. In some embodiments, elastomeric materials and compositions provided herein can also provide certain advantages from an environmental, manufacturing and/or cost perspective, due to the solvent-free preparation, use, and recycling/re-use thereof.

Polycaprolactone (PCL) is a biocompatible semi-crystalline polymer, which is widely used in shape memory polymers and biomaterials.

Many different elastomers may be used. Examples of elastomer polymers may include polyolefins, polysiloxanes, polychloroprene, and polysulfides. Examples of polyolefin elastomers include polyisoprene (including natural rubber), polyisobutylene, polybutadiene, poly(cyclooctadiene), and poly(norbornene). Examples of polysiloxane elastomers include poly(dimethylsiloxane)(PDMS), poly(methylsiloxane), partially alkylated poly(methyl siloxane), poly(alkyl methyl siloxane) and poly(phenyl methyl siloxane). Examples of polysulfide elastomers include crosslinked polybis(ethylene oxy)-2-disulfide (Thiokol).

In certain embodiments of the present technology, the elastomer is a polysiloxane. In one embodiment, the elastomer is polydimethylsiloxane (PDMS).

In certain embodiments of the present technology, the elastomer is a polyether. In one embodiment, the elastomer is poly(propylene oxide)(PPO).

Examples of copolymer elastomers may include polyolefin copolymers and fluorocarbon elastomers. Examples of polyolefin copolymer elastomers include copolymers containing monomer units derived from ethylene, propylene, isoprene, isobutylene, butadiene and/or other dienes, and which may also contain monomer units derived from non-olefins, such as acrylates, alkylacrylates and acrylonitrile. Specific examples of polyolefin copolymer elastomers include ethylene-propylene-diene copolymer (EPDM), butadiene-acrylonitrile copolymer (nitrile rubber, NBR), isobutylene-isoprene copolymer (butyl rubber) and ethylene-acrylate copolymers. Examples of fluorocarbon elastomers include copolymers containing monomer units derived from hexafluoropropylene, vinylidene fluoride, tetrafluoroethylene and/or perfluoromethylvinylether.

Examples of block copolymer elastomers may include acrylonitrile block copolymers, polystyrene block copolymers, polyolefin block copolymers, polyester block copolymers, polyamide block copolymers, and polyurethane block copolymers. Examples of acrylonitrile block copolymer elastomers include styrene-acrylonitrile (SAN), and acrylonitrile-styrene-acrylate. Examples of polystyrene block copolymer elastomers include block copolymers of polystyrene, poly(C-methylstyrene) or other substituted polystyrenes with polyolefinelastomers, polyolefin copolymer elastomers, polysiloxanes or poly(alkylacrylates). Examples of polyolefin block copolymer elastomers include block copolymers of polyethylene or isotactic polypropylene with poly(C-olefins) or polyolefin copolymer elastomers.

Examples of polyester block copolymer elastomers include block copolymers of polyesters with polyethers. Examples of polyamide block copolymer elastomers include block copolymers of polyamides with polyesters or polyethers. Examples of polyurethane block copolymer elastomers include block copolymers of polyurethanes with polyethers or polyesters.

Examples of polymer blend elastomers include mixtures of polypropylene with polyolefinelastomers, polyolefin copolymer elastomers, polyolefin block copolymer elastomers, polypropylene copolymers or poly(ethylene-co-vinyl acetate). Examples of polymer blendelastomers include mixtures of butadiene-acrylonitrile copolymer elastomer (NBR) with polyamides or poly(vinyl chloride). Examples of polymer blend elastomers include mixtures of polysiloxane elastomers with polyesters or polyamides. Examples of polymer blend elastomers include mixtures of polyacrylates with polyolefins or with block copolymer elastomers containing blocks of polyurethanes, polyamides, or polyesters. One or more of the polymers in a polymer blend may be crosslinked to provide an interpenetrating network.

The elastomer matrix may include more than one type of elastomer. In addition, the elastomer may be modified, for example by crosslinking, by chemical modification to introduce or to protect functional groups, by grafting of polymer chains, or by surface treatments. The elastomer matrix can include other ingredients in addition to the elastomer. For example, the matrix can contain stabilizers, antioxidants, flame retardants, plasticizers, colorants and dyes, odorants, particulate fillers, reinforcing fibers, and adhesion promoters.

In some embodiments, self-healing elastomeric materials and compositions provided herein comprise a polymerizer. A polymerizer generally includes a polymerizable substance such as a monomer, a prepolymer, or a functionalized polymer having two or more reactive groups. The polymerizer optionally may contain other ingredients, such as other monomers and/or prepolymers, stabilizers, solvents, viscosity modifiers such as polymers, inorganic fillers, odorants, colorants and dyes, blowing agents, antioxidants, and co-catalysts. A polymerizer also may contain one part of a two-part catalyst, with a corresponding initiator being the other part of the two-part catalyst. In some embodiments, a polymerizer is a liquid.

Examples of polymerizable substances include functionalized siloxanes, such as siloxane prepolymers and polysiloxanes having two or more reactive groups. Functionalized siloxanes include, for example, silanol-functional siloxanes, alkoxy- and alkylamino functional siloxanes and allyl- or vinyl-functional siloxanes. Examples of polymerizable substances also include epoxy-functionalized monomers, prepolymers or polymers. Examples of polymerizable monomers include cyclic olefins, preferably containing from 4 to 50 carbon atoms and optionally containing heteroatoms, such as DCPD, substituted DCPD, norbornene, substituted norbornene, cyclooctadiene, and Substituted cyclooctadiene. Examples of polymerizable monomers also include olefins such as ethylene, propylene, C.-olefins, isoprene, isobutylene, butadiene and other dienes. Examples of polymerizable monomers also include other unsaturated monomers such as 2-chloro-1,3-butadiene (chloroprene), styrenes, acrylates, alkylacrylates (including methacrylates and ethacrylates), acrylonitrile, hexafluoropropylene, vinylidene fluoride, tetrafluoroethylene and perfluoromethylvinylether. Examples of polymerizable monomers also include lactones such as caprolactone, and lactams, that when polymerized will form polyesters and nylons, respectively.

One example of a polymerizer for an elastomer is a siloxane polymerizer, which may form a polysiloxane elastomer when contacted with a corresponding activator. A polysiloxane elastomer formed from a siloxane polymerizer may be a linear or branched polymer, it may be a crosslinked network, or it may be a part of a block copolymer containing segments of polysiloxane and another polymer. Examples of polysiloxane elastomers include poly(dimethylsiloxane), poly(methylsiloxane), partially alkylated poly(methyl siloxane), poly(alkyl methyl siloxane) and poly(phenyl methyl siloxane). In certain embodiments, the siloxane polymerizer forms poly(dimethylsiloxane), referred to as “PDMS.” A siloxane polymerizer for PDMS may include a monomer, such as the cyclic siloxane monomer octamethylcylo-tetrasiloxane. A siloxane polymerizer for PDMS may include a functionalized siloxane, such as a prepolymer or a polymer containing dimethyl siloxane repeating units and two or more reactive groups.

In certain embodiments of elastomeric materials and compositions provided herein, the elastomer material can comprise and/or involve a flexible polymer backbone, such as, without limitation, polydimethylsiloxane (PDMS), polyethyleneoxide (PEO), poly(propylene oxide) (PPO), polytetrahydrofurane, perfluoropolyether (PFPE), polybutylene (PB), poly (ethylene-co-1-butylene), poly (butadiene), hydrogenated poly (butadiene), poly (ethyl ene oxide)-poly (propylene oxide) block copolymer or random copolymer, and poly (hydroxyalkanoate), with a particular ratio of at least a first type of moieties that provide a first number of dynamic bonds resulting from interactions between the first type of moieties (e.g., hydrogen or other bonding sites with relatively strong bonds) and a second type of moieties that provide a second number of dynamic bonds resulting from interactions between the second type of moieties (e.g., hydrogen or other bonding sites of a weaker bonding strength than the first number of hydrogen or other binding sides or with relatively weak bonds) in polymer chains, and films formed therefrom. As may be appreciated, dynamic bonds include or refer to bonds that can be reformed, once broken due to mechanical forces, at room temperature or elevated temperature, such as hydrogen bonds, metal-ligand bonds, guest-host interactions, and/or supramolecular interactions. Such films can exhibit self-healing, are tough, and are stretchable.

In some embodiments, a polymer film can include a polydimethylsiloxane (PDMS) polymer backbone with a particular ratio of polyurethane (PU).

In some embodiments of elastomeric materials and compositions provided herein, the molecular weight of the soft segments of elastomeric material may range from about 500 to about 30,000.

In some embodiments of the present technology, there are provided methods and apparatus comprising and/or involving use of the elastomeric materials and compositions and skin-like materials provided herein. Such materials may be provided in the form of a polymer film. In some embodiments, the the elastomeric materials and compositions and skin-like materials provided herein exhibit intrinsic and/or thermal self-healing properties and one or more of the following properties: can be stretched up to 1,200 percent strain without rupturing; can be stretched up to 3,000 percent; Young's modulus of between 0.22 and 1.5 MPa; exhibits notch-insentitive stretching; exhibits a fracture energy of around 12,000 J/m².

It should be understood that the amounts of the components in the elastomeric materials and compositions and skin-like materials provided herein may be adjusted to optimize mechanical properties such as, without limitation, fracture strain, Young's modulus, self-healing efficiency, etc.

In some embodiments, elastomeric materials and compositions may comprise about 0-50 wt % of a reinforcing filler such as, without limitation, nanocrystalline cellulose (NCC) or clay (e.g., montmorillonite, silicon dioxide (SiO₂), or kaolin clay). In alternative embodiments, a reinforcing filler is not included. In some embodiments, a nanocrystalline filler is a nanocrystalline polymer. Many nanocrystalline and semi-crystalline polymers are known and may be used as nanocrystalline fillers elastomeric materials and compositions described here. In an embodiment, a cellulose-based polymer is used as a nanocrystalline filler. Examples of cellulose-based polymers include hydroxypropyl cellulose (HPC), microcrystalline cellulose (MCC) and nanocrystalline cellulose (NCC). In an embodiment, a nanocrystalline filler comprises nanocrystalline cellulose (NCC). In another embodiment, a nanocrystalline filler is a nanocrystalline starch, a nanoclay, a carbon nanotube, an organic nanoclay, an organoclay, a clay, or any electrospun polymer nanofiber. Non-limiting examples of nanocrystalline fillers include montmorillonite, bentonite, kaolinite, hectorite, halloysite, and liquid crystalline polymers such as Poly(γ-benyzl glutamate). In an embodiment, a nanocrystalline filler comprises clay. Many different types of clay may be used, including without limitation montmorillonite, silicon dioxide (SiO₂), and/or kaolin clay.

In some embodiments, elastomeric materials and compositions comprise one or more additive to improve various properties of the compositions. Examples of suitable classes of additives include without limitation plasticizers, antioxidants, paints (e.g., acrylic paint), dyes, and other colouring agents. Non-limiting examples of suitable plasticizers include high molecular weight hydrocarbon oils, high molecular-weight hydrocarbon greases, Pentalyne H, Piccovar® AP Hydrocarbon Resins, Admex 760, Plastolein 9720, silicone oils, silicone greases, Floral 105, Benzoflex™, silicone elastomers, nonionic surfactants, and the like, and combinations thereof.

Generally, an additive may improve any polymer property or parameter related to suitability for the desired application. The addition of a plasticizer may, for example, improve the functioning of an elastomeric material or composition provided herein by increasing the elastic modulus of the polymer and/or increasing the thermoplasticity of the polymer. In one embodiment, an additive is included in a polymer to improve the elasticity, stretchability, softness, color, thermoplasticity, self-healing properties, and/or toughness, etc. of the polymer.

Additives may also be used to improve performance of one or more material properties, for example to stabilize a formulation, to provide additional functional properties, to facilitate crosslinking to a substrate or article, to provide adhesive properties, etc. In certain embodiments, one or more than one additive is used. Non-limiting examples of additives to be used with elastomeric materials and compositions provided herein include fixatives, rheology modifiers, UV stabilizers, plasticizers, surfactants, fluorosurfactants, emulsifiers, antistatic additives, flame retardants, friction reduction agents, anti-blocking agents, freezing point depressants, IR reflecting agents, crosslinking agents, and lubricants. Additives are chosen by the skilled artisan based on the elastomeric materials used, desired properties, desired uses and applications, and so on.

In some embodiments, components of elastomeric materials and compositions may be chemically modified.

### General Structure of Skin-Like Materials

In some embodiments, there are provided skin-like materials comprising elastomeric materials and compositions provided herein. Skin-like materials generally comprise multiple layers, e.g., to simulate the layers of skin, fat and muscle that occur in natural skin.

The structure of the skin-like materials of the present technology is not particularly limited and the number, size and configuation of layers may vary, depending on many factors such as the particular application.

### Fabrication

There are provided methods for fabricating elastomeric materials and compositions and skin-like materials described herein. As these may be implemented in a broad range of applications, it should be understood that fabrication processes used with the present technology may vary greatly and are not particularly limited.

Elastomeric materials and compositions and skin-like materials may be made using standard techniques known in the art, such as without limitation casting, solution casting, dipping, spin coating, spraying, compression molding or other known processes for fabrication of thin polymer layers. In a particular embodiment, materials and compositions are preparable or are prepared using extrusion techniques known in the art, e.g. using a single or twin screw extruder, e.g., by blown film extrusion, sheet/film extrusion, coextrusion, and the like. In an embodiment, elastomeric films and skin-like materials are made using extrusion (e.g., a twin-screw extruder) to prepare the elastomeric composition and then compression molded into a film. In another embodiment, elastomeric films are made using twin-screw extrusion followed by a sheet/film extrusion (slit die) to make elastomeric film in a continuous process. In some embodiments, materials of the present technology, and apparatuses and articles incorporating the materials of the present technology, may be fabricated using 3D or 4D printing.

In some embodiments, there are provided methods for preparation of elastomeric materials of the present technology that use minimal solvent or are solvent-free (also referrred to herein as “bulk” synthesis). Such methods can be advantageous from both a manufacturing and environmental perspective (e.g., less chemicals, lower cost, etc.).

It should be understood that the structure of the skin-like material is not meant to be limited, and the number of layers, the configuration of the layers, etc. may all be varied depending on the desired application and properties. Thus many different skin-like materials may be produced, and skin-like materials may be prepared using a wide range of methods.

### Applications and Articles of Manufacture

Elastomeric materials and compositions, and skin-like materials thereof, find use in a wide range of applications and may be incorporated in a wide variety of articles.

Non-limiting examples of other devices or articles which may be made incorporating elastomeric materials and compositions and skin-like materials described herein include a wide variety of industrial, medical, consumer, and electronics applications, as described herein. In some embodiments, elastomeric materials and compositions and skin-like materials described herein can be integrated into a medical device to act as an artificial sphincter, an artificial heart, an artificial skeletal muscle or a simulation of a human (e.g., a mannequin-simulator) to replicate muscle and nerve functions for medical training.

In some embodiments, elastomeric materials and compositions and skin-like materials described herein can be integrated into a wearable. As used herein, “wearable” refers to an item which can be worn or placed on a body or body part. For example, a wearable may be an article of apparel, such as without limitation a garment. A wearable may also be an electronically controlled or operated device such as a sensing device, a fitness monitor, and the like.

In some embodiments, elastomeric materials or compositions and skin-like materials described herein may be used in anatomical models for medical or surgical training. In some embodiments, there is provided an anatomical model for medical or surgical training comprising one or more elastomeric material or composition or skin-like material described herein. In some embodiments, the skin-like material may have electrochromic properties, e.g., it may change color responsive to certain manipulations of the model, providing feedback to the user. In some embodiments, the skin-like material may be self-healing, e.g., after being used for training, it can self-heal, intrinsically or thermally, allowing use in multiple training sessions. In some embodiments, this re-use/multi-use capability of the anatomical models provided herein can provide significant advantages over available models, which are limited to single-use only.

In some embodiments, elastomeric materials or compositions and skin-like materials described herein may be used in medical simulators.

In some embodiments, elastomeric materials or compositions and skin-like materials described herein may be used in high-fidelity three-dimensional surgical training models (e.g., mannequin) for demonstrating or practicing surgical techniques. In some embodiments, the three-dimensional surgical training model simulates human tissues of the head, neck and shoulders. Other body parts may also be simulated. In some embodiments, the human body is simulated. The three-dimentional surgical training model is not meant to be particularly limited and may encompass any body part(s), or combinations thereof, as appropriate for the designated use. In some embodiments, the three-dimensional surgical training model may comprise a wide variety of defects, including but not limited, to various cutaneous defects, for demonstration or training purposes.

In some embodiments, a three-dimensional surgical training model comprises a skin-simulating layer, a muscle-simulating layer, cartilage-simulating structures, gland-simulating structures, and/or a skull-simulating structure.

In some embodiments, a self-healing three-dimentsional surgical training model comprises cutaneous defect-simulating structures embedded within the skin-simulating layer and blood vessel-simulating structures laminated onto the skin-simulating layer. The muscle-simulating layer may comprise, for example, artery-simulating structures, nerve-simulating structures, and gland-simulating structures laminated onto the muscle-simulating layer. The muscle-simulating layer may further comprise a superficial musculoaponeurotic system-simulating layer laminated onto the muscle-simulating layer, wherein the artery-simulating structures, the nerve-simulating structures, and/or the gland-simulating structures are subjacent to the superficial musculoaponeurotic system-simulating layer and are superficial to the muscle-simulating layer. In some embodiments, the muscle-simulating layer is laminated onto the skin-simulating layer and onto the skull-simulating layer.

Another embodiment of the present technology relates to a method of training medical practitioners, comprising providing a reusable, self-healing three dimensional surgical training model and performing surgical techniques upon the three-dimensional surgical training model.

Another embodiment of the present technology relates to a self-healing artificial skin or skin-like material for fabricating a three-dimensional surgical training model.

In some embodiments, the three-dimensional surgical training model is reusable/suitable for multi-use, due to the self-healing (intrinsic and/or thermal) properties of the artificial skin or skin-like material used therein.

As used herein, the term “cutaneous’ means relating to or existing on or affecting the skin.

In some embodiments, the self-healing surgical training model provided herein is high-fidelity. As used herein, “high fidelity” means an accurate simulation of the anatomy and/or physical properties of human tissue.

In some embodiments, the present technology comprises a surgical training model that simulates human tissues and is reusable/suitable for multi-use, comprising a self-healing artificial skin or skin-like material, as described herein. The surgical training model may also comprise a variety of cutaneous defects, including but not limited to lesions and/or wounds. As used herein, “lesion” means any localized abnormal structural change and “wound’ means any injury to a tissue.

In some embodiments, the surgical training model comprises tissue-simulating layers. In one particular embodiment, the tissue-simulating layers may comprise a skin-simulating layer, blood vessel-simulating structures, cutaneous defect-simulating structures, a muscle-simulating layer, artery-simulating structures, nerve-simulating structures, a superficial musculoaponeurotic system-simulating structure, gland-simulating structures, cartilage-simulating structures and/or skull-simulating structures, and combinations thereof.

In one embodiment, the epidermis-simulating layer may comprise one or more materials, including but not limited to plastics, polymers, composites, other materials, additives, and/or combinations thereof. In certain embodiments, the epidermis-simulating layer 3 may comprise elastomeric materials such as, for example, elastomers (synthetic and natural), rubbers (synthetic and natural), polyisobutene, polyisoprene, polysiloxane, polyetherurethane, polyurethane, other materials (known or yet-to-be discovered), additives, and/or combinations thereof such that the epidermis simulating layer possesses similar or the same characteristics, such as substantially the same or similar tensile strength and/or elongation at break point as that of the actual epidermal layer in humans. As such, the epidermis simulating layer may be comprised of an elastomeric material having a tensile strength from about 150 psi (about 1.0 MPa) to about 500 psi (about 3.4 MPa), in another embodiment from about 225 psi (about 1.5 MPa) to about 500 psi (about 3.4 MPa), in another embodiment from about 300 psi (about 2.1 MPa) to about 500 psi (about 3.4 MPa), in still another embodiment from about 400 psi (about 2.8 MPa) to about 500 psi (about 3.4 MPa), and still yet another embodiment from about 450 psi (about 3.1 MPa) to about 500 psi (about 3.4 MPa), and an elongation at break point from about 700% to about 1100%, in another embodiment from about 800% to about 1100%, in still another embodiment from about 900% to about 1100%, or in still yet another embodiment from about 950% to about 1100%.

In one embodiment, the epidermis-simulating layer comprises a mixture of a polysiloxane, more particularly PDMS. In one embodiment, the epidermis-stimulating layer comprises a mixture of PDMS and PU.

In one embodiment, the epidermis-simulating layer comprises a mixture of a polysiloxane, more particularly PDMS.

In one embodiment, the epidermis-stimulating layer comprises a mixture of PPO and PU.

In one embodiment, the epidermis-stimulating layer comprises the self-healing elastomeric material or composition provided herein.

In one particular embodiment, the epidermis-simulating layer further comprises a synthetic polymer layer, and more particularly comprises a polyfiber layer. The polyfiber layer adds support to the epidermis-simulating layer. In one particular embodiment, the polyfiber layer comprises SF-8 Supreme Polyfiber. In one embodiment, the thickness of the epidermis simulating layer is about 0.5 mm to about 1.0 mm. The epidermis-simulating layer may further comprise the addition of a paint or dye or other coloring agent to simulate the pigmentation of human epidermal tissue. In one particular embodiment, the dye is an oil-based flesh tone pigment. In another particular embodiment, the coloring agent is an acrylic paint.

In some emdbodiments, upon incorporating blood vessel-simulating structures into the lower dermis-simulating layer, at least one layer of polyamide mesh is laminated onto the blood vessel simulating structures incorporated into the lower dermis simulating layer. In one particular embodiment, approximately eleven layers of polyamide mesh are laminated onto the blood vessel-simulating structures incorporated into the lower dermis-simulating layer. In one embodiment, the thickness of the lower dermis-simulating layer is about 1.0 mm to about 1.5 mm. The dermis-simulating layer may further comprise the addition of a paint or a dye or another coloring agent to simulate the pigmentation of a human dermal tissue. In one particular embodiment, the dye is an oil-basedflesh-tone pigment, lighter than the pigmentation of the epidermis-simulating layer. In another particular embodiment, the coloring agent is an acrylic paint.

With regard to elongation, in one embodiment, the epidermis-simulating layer and the dermis-simulating layer may have an elongation at break point of from about 50% to about 100% of the original length and in addition to the original length of the epidermis-simulating layer and the dermis-simulating layer, in another embodiment from about 60% to about 100% of the original length and in addition to the original length, in yet another embodiment from about 70% to about 100% of the original length and in addition to the original length, in still another embodiment from about 75% to about 100% of the original length and in addition to the original length.

In some embodiments, the cutaneous defect-simulating structures may comprise one or more materials, including but not limited to plastics, polymers, composites, other materials, additives, and/or combinations thereof. In certain embodiments, the cutaneous defect-simulating structures may comprise elastomeric materials such as, for example, elastomers (synthetic and natural), rubbers (synthetic and natural), polyisobutene, polyisoprene, polysiloxane, polyetherurethane, polyurethane, PPO, other materials (known or yet-to-be discovered), additives, and/or combinations thereof such that the cutaneous defect-simulating structures possess similar or the same characteristics, such as substantially the same or similar tensile strength, and/or elongation at break point as that of typical cutaneous defects (e.g., tumors, lesions, wounds, scars, etc.) in humans.

In some embodiments, the subcutaneous-simulating layer is subjacent to the dermis-simulating layer. The subcutaneous-simulating layer may comprise an elastomer of low compression and hardness to a durometer reading of about 0. In one embodiment, the Subcutaneous-simulating layer may comprise one or more materials, including but not limited to plastics, polymers, composites, other materials, additives, and/or combinations thereof. In certain embodiments, the subcutaneous simulating layer may comprise elastomeric materials such as, for example, elastomers (synthetic and natural), rubbers (synthetic and natural), polyisobutene, polyisoprene, polysiloxane, polyetherurethane, polyurethane, PPO, other materials (known or yet-to-be discovered), additives, and/or combinations thereof such that the subcutaneous-simulating layer possesses similar or the same characteristics, such as substantially the same or similar tensile strength, and/or elongation at break point as that of actual subcutaneous layer in humans.

In one embodiment, the subcutaneous simulating layer comprises a mixture of polysiloxane with a polysiloxane softener. In a further embodiment, the polysiloxane comprises PDMS. In another embodiment, the subcutaneous simulating layer comprises a mixture of PDMS and PU. In another embodiment, the subcutaneous simulating layer comprises PPO.

In one embodiment, the skin-simulating layer, which may comprise an epidermis-simulating layer, a dermis-simulating layer, and a subcutaneous-simulating layer, of an embodiment of the surgical training model has a tensile strength of from about 16 MPa to about 20 MPa, an elongation at break of from about 65% to about 75%, and a durometer hardness of from about 4 to about 6.

In some embodiments, the three-dimensional surgical model comprises an epidermis-simulating layer (e.g., artificial skin, skin-like material), a muscle simulating layer, and a subcutaneous-simulating layer (e.g., fat simulating layer). The muscle-simulating layer msy be subjacent to the subcutaneous-simulating layer. In some embodiments, the muscle-simulating layer may simulate superficial muscles of the head and neck. The muscle-simulating layer may comprise one or more materials, including but not limited to plastics, polymers, composites, other materials, additives, and/or combinations thereof. In certain embodiments, the muscle-simulating layer may comprise elastomeric materials such as, forexample, elastomers (synthetic and natural), rubbers (synthetic and natural), polyisobutene, polyisoprene, polysiloxane, polyetherurethane, polyurethane, PPO, other materials (known or yet-to-be discovered) such as alginate, additives, and/or combinations thereof such that the muscle-simulating layer possesses similar or the same characteristics, such as substantially the same or similar tensile strength, and/or elongation at break point as that of actual muscle tissues in humans. In one embodiment, the muscle-simulating layer comprises a mixture of an elastomer of high tensile strength and alginate to a durometer hardness of about 10 to about 12.

In some embodiments, the three-dimensional surgical model comprises artery-simulating structures. Artery-simulating structures may comprise one or more materials, including but not limited to plastics, polymers, composites, filaments, filaments encompassed, encircled, or embedded within polymer or composite materials, other materials, additives, and/or combinations thereof.

In certain embodiments, the artery-simulating structures may comprise elastomeric materials such as, for example, elastomers (synthetic and natural), rubbers (synthetic and natural), polyisobutene, polyisoprene, polysiloxane, polyetherurethane, polyurethane, polyamide, PPO, other materials (known or yet-to-be discovered), additives, and/or combinations thereof such that the artery-simulating structures possesses similar or the same characteristics, such as substantially the same or similar tensile strength and/or elongation at break point as that of actual arteries in humans. In one embodiment, the artery-simulating structures are individually composed and are laminated onto the muscle-simulating layer, prior to lamination of the muscle-simulating layer onto the subcutaneous-simulating layer.

In some embodiments, the present technology relates to methods for training medical practitioners, and more specifically surgical residents and fellows, in a variety of surgical techniques. The methods comprise providing a reusable three-dimensional surgical training model as described herein and performing surgical techniques upon the surgical training model. In one embodiment, the method of training comprises the use of a surgical training model to train surgical residents and fellows how to perform a variety of surgical techniques, including but not limited to excision techniques, closure techniques, and cosmetic procedures, and combinations thereof. In certain embodiments, the method of training comprises repairing cuts, lesions, wounds or scars formed in the surgical model after a first training session such that the surgical model can be used in a second (or subsequent) training session, i.e., treating the surgical model so that the self-healing properties of the elastomeric material or composition or artificial skin allow repair after a first training session is completed, in preparation for a second or subsequent training session. Such treatment or repair may comprise bringing the edges of a cut, leasion, wound or scar together, in the case of intrinsically self-healing materials or skin-like structures, so that the material will autonomously self-heal, or may comprise heating and pressing the edges together for thermal self-healing, as described herein.

Non-limiting examples of surgical procedures that may be taught or practiced using surfical training models of the present technology include closure techniques such as flap and graft closures, single and double advancement flaps, rotational flaps, hinge flaps, bilobed transpositional flaps, forehead flaps, rhomboid flaps, Z-plasty flaps, nasolabial tranpositional flaps, and Estlander flaps. In an alternative embodiment, graft closures may comprise island pedicle grafts and full thickness skin grafts. Additionally, the closure techniques may further comprise primary closures and resec tions. In a further embodiment, resections may comprise a wedge-shape resection. It should be understood that the surgical techniques that can be used in methods of the present technology are not particularly limited and could include a wide range of such techniques.

In some embodiments, the artificial skin layer and/or the three-dimensional surgical model comprised at least one blood vessel-simulating structure embedded therein such that synthetic blood may be injected into the at least one blood vessel-simulating structure to simulate bleeding upon demonstrating or practicing surgical techniques thereon. Blood vessel-simulating structures may be arranged in correct anatomical positions. Blood vessel-simulating structures may be provided as channels into which synthetic blood is injected, in order to simulate blood vessels.

As used herein, “extension ratio” is defined as maximum length to which a polymer or material or skin-like structure can be stretched divided by its original length, and provides a measure of stretchability. Streatchability is generally determined based on extension ratio.

In some aspects of the present technology, self-healing elastomer materials or compositions and skin-like materials are used for wearable electronic skin, wearable electronic devices, protective coatings, for 3D/4D printing, for reversible adhesion, for self-healing conductors, and so on. Wearable electronic devices can be deposited on the elastomer surface due to the excellent elastic properties. In case any mechanical damage happens, the elastomer substrates can repair themselves which will also lead to the self-healing of the device. For coatings, self-healing capability of the materials will repair the surface scratch, and protect the substrate fromexposure to the environment. For adhesive materials, the dynamic bond in the polymer networks can be cleaved and will induce a sharp decrease of the materials' viscosity and thus promote a tight bonding. The broken dynamic bonds can be reformed together after removing the external stimuli, and thus will induce strong adhesion between the substrates and the elastic materials. The viscosity transition mechanism also plays an important role in the 3D/4D printing of self-healing elastomers. By introducing conductive fillers into self-healing elastomers, self-healing conductors can be made. Self-healing of these materials will induce the fracture surface to contact again and repair the conductive path during this process. Further potential applications are discussed in Wang et al. J. Mater. Chem. B, 2019, DOI: 10.1039/c9tb00831d.

In some embodiments, skin-like materials described herein have one or more of the following performance characteristics: instrinsic self-healing; thermal self-healing; tough; stretchable; transparent; high-fidelity; tough; self-healing without requiring liquid (water, sweat, solvent, etc.); self-healing through chemical interactions (hydrogen bonding and/or thermoreversible disulfide bond re-formation or metathesis); and realistic properties of naturally-occurring human skin, i.e., similar or the same characteristics as actual skin in humans, such as substantially the same or similar tensile strength and/or elongation at break point and/or extension ratio and/or elasticity and/or Young's modulus and/or fracture strain and/or shape recovery ability.

In some aspects of the present technology, self-healing elastomer materials or compositions and skin-like materials are used to form bulk films, three-dimensional self-healable objects, wearable electronics, wearable citcuitry, robotic applications, self-healable electrodes, self-healable capacitive strain sensors, an array of strain sensors, surgical training models and mannequins, and the like. Various specific aspects of the present technology are directed to using the self-healing elastomer materials or compositions and skin-like materials disclosed herein, in a wide variety of such applications. As with the remarkable network of sensitive diverse sensors provided by human skin, certain aspects of the present technology are applicable for tactile sensing, health monitoring, and temperature sensing. Consistent with various embodiments, wearable circuitry including electronic sensors (e.g., force and otherwise) may be formed using the self-healing elastomer materials or compositions and skin-like materials of the present technology. As with human skin, particular embodiments include electronic skin-like (e.g., e-skin) devices which mimic properties of human skin for applications such as wearable devices, artificial prosthetics, health monitoring, smart robots, and surgical training models and mannequins. In this context, e-skin is an artificial skin that mimics properties of skin using surface-interfacing structures which are integrated with electronics (e.g., electronic circuitry).

In accordance with various embodiments, the self-healing elastomer materials or compositions and skin-like materials of the present technology do not require liquid for self-healing to take place. Surprisingly, unlike conventional self-healing elastomer materials, a liquid such as water, sweat, solvent, etc. is not required for self-healing to take place. Rather, self-healing materials undergo chemical and/or physical interactions (such as hydrogen bonding, disulfide bond formation, etc.) for self-healing, either autonomously (without requiring additional external stimulus, as in intrinsic self-healing) or with application of heat and pressing (as in thermal self-healing).

In an embodiment, the self-healing elastomer materials or compositions and skin-like materials of the present technology are used to simulate blood (artificial blood), i.e., blood that can move and clot like real blood when triggered.

In an embodiment, the self-healing elastomer materials or compositions and skin-like materials of the present technology are used to simulate parts of the face and mouth such as lips. Simulated lips provided herein can be triggered to turn blue to simulate cyanosis.

In an embodiment, the self-healing elastomer materials or compositions and skin-like materials of the present technology are used to simulate smooth skin. The simulated smooth skin provided herein can be triggered to undergo a colorimetric transformation to simulate a rash or a hematoma.

In an embodiment, the self-healing elastomer materials or compositions and skin-like materials of the present technology are used to simulate muscles. Artificial muscles in accordance with the present technology can be combined with electroactive polymer compositions that function as actuators, such that mannequins comprising the artificial muscles can move, simulating human movement.

In an embodiment, the self-healing elastomer materials or compositions and skin-like materials of the present technology are used to simulate soft and/or smooth interfaces that respond to touch, force and/or pressure like human skin.

In an embodiment, the self-healing elastomer materials or compositions and skin-like materials of the present technology are used to simulate skin that can heals on its own or “on command” when repeatedly jabbed or cut.

In an embodiment, the self-healing elastomer materials or compositions and skin-like materials of the present technology are used for fabrication of a surgical simulators, e.g., for demonstration or practice of anastomosis or ressections procedures for training purposes.

It should be understood that simulated materials, organs, body parts, mannequins, training models, etc., can all be reused multiple times, due to the self-healing properties of the elastomeric materials used.

In an embodiment, there are provided 3D or 4D printed organ models that look, feel, and mimic actual organs.

In an embodiment, there are provided sophisticated task trainers for complex surgical procedures such as Caesarian (C-) sections, anastomosis and ressections.

In an embodiment, there are provided medical simulators and mannequins and other apparatuses and devices for which physiological color changes can be triggered on demand. Such color changes are also reversible.

In an embodiment, there are provided sophisticated medical simulators that can simulate cyanosis, hematomas and rashes.

In an embodiment, there are provided artificial muscles that can mimic human articulations, tearing and contractions, on demand.

In an embodiment, there are provided sensing interfaces that can feel and sense stimuli like human skin.

In some embodiments, medical simulators can be provided as portable units that can be easily integrated into existing mannequins. For example, they can be provided as a “plug and play” modeule that can be integrated into an existing mannequin and confer properties described herein, such as movement, when combined with actuating polymers.

In some embodiments, medical simulators can be provided inside a box for training suturing techniques. For example, a “Smart Suture Box” comprising multilayer skin constructs with a built-in skin repair and healing module can be provided.

In an embodiment, there is provided a synthetic blood that can flow like real blood and can coagulate and form clots of varying sizes when triggered.

In some aspects of the present technology, elastomeric materials and compositions and skin-like materials, and articles incorporating them, can have multiple functionalities. For example, in addition to self-healing properties as described herein, materials and articles may be able to change color and/or to move, in response to a stimulus.

In some embodiments, materials and compositions are combined with electrochromic materials to confer the ability to change color in response to certain manipulations or stimuli. For example, a surgical model may change color responsive to certain manipulations, e.g., to simulate cyanosis or a rash. In some such embodiments, self-healing elastomeric materials are combined with colorimetric or electrochromic materials to allow color changes when desired, e.g., to simulate cyanosis, rashes, and the like.

In some embodiments, materials and compositions are combined with electroactive materials, such as electroactive polymer actuators that convert between electrical energy and mechanical energy. Such materials may confer e.g., the ability to move in response to an electrical stimulus. For example, a surgical model of a hand can be configured to move or lift a finger in response to a stimulus. In some such embodiments, self-healing elastomeric materials are combined with stretchable solid-state electroactive polymer actuators using electroactive polymers that convert between electrical energy and mechanical energy (e.g., solid-state polymeric actuators, generators, sensors, and other energy transducers). Such materials have been described for example in International PCT Application No. PCT/CA2019/050772, the entire contents of which are incorporated herein by reference. Such combinations are particularly useful for simulating movement, e.g., for providing artificial muscles and the like that can move in response to stimuli. Medical training simulators and mannequins with multiple functionalities can thus be provided.

In some embodiments, an anatomical model for medical or surgical training can be provided that comprises one or more elastomeric material or composition of the present technology and one or more electroactive polymer composition, e.g., a solid-state electroactive polymeric actuator, such as without limitation those described in International PCT Application No. PCT/CA2019/050772.

In some embodiments, a robotic surgical tool can be provided that comprises one or more elastomeric material or composition of the present technology and one or more electroactive polymer composition, e.g., a solid-state electroactive polymeric actuator, such as without limitation those described in International PCT Application No. PCT/CA2019/050772.

Based upon the foregoing, those skilled in the art will readily recognize that various modifications and changes may be made to the various embodiments without strictly following the exemplary embodiments and applications illustrated and described herein. Such modifications do not depart from the true spirit and scope of various aspects of the disclosure, including aspects set forth in the claims.

### EXAMPLES

The present invention will be more readily understood by referring to the following examples, which are provided to illustrate the invention and are not to be construed as limiting the scope thereof in any manner.

Unless defined otherwise or the context clearly dictates otherwise, all technical and scientific terms used herein have the same meaning as commonly understood by one of ordinary skill in the art to which this invention belongs. It should be understood that any methods and materials similar or equivalent to those described herein can be used in the practice or testing of the invention.

### Example 1

### Preparation of Low-Temperature Thermal Self-Healing PDMS-Based Elastomeric Material (Polyurethane/Urea)

A low-temperature thermal self-healing PDMS-based elastomeric material (SH26) was prepared. The components are shown in Table 1.

TABLE 1
Components for production of 10 g of SH26.

| | Abbreviated | | Mw | | |
|---|---|---|---|---|---|
| Compound name | name | CAS # | (g/mol) | Amount | |
| Aminopropyl | NH₂-PDMS-NH₂ | 106214-84-0 | 3000 | 10 | g |
| terminated | | | | | |
| polydimethylsiloxane | | | | | |
| 2-Hydroxyethyl | HO—SS—OH | 1892-29-1 | 154.25 | 0.642 | g |
| disulfide | | | | | |
| Hexamethylene | HMDI | 822-06-0 | 168.19 | 1.028 | mL |
| diisocyanate | | | | | |
| Dibutyltin | DBTA | 1067-33-0 | 351.03 | 10 | drops |
| diacetate | | | | | |
| HDI isocyanurate | DESMO | 3779-63-3 | 504.6 | 0.284 | g |
| trimer | N3300 | | | | |
| Dichloromethane | DCM | 75-09-2 | 84.93 | 40 | mL |

A solvent-assisted procedure was performed as follows: PDMS and disulfide were placed in a 250 mL beaker with 30 mL DCM. A stir bar was added and the mixture was stirred at 700 RPM for 1-2 minutes. HDMI was then added drop wise (over 5 minutes) with a micropipette. This was stirred for 10 min (cold and thickening due to DCM evaporation should be observed, and the system should stay liquid enough to stir). 10 drops of DBTA were added and stirred for 20 minutes. During this time, DESMO was dissolved in 10 mL DCM. After 20 minutes, the main product should look opalescent and viscous.

At this step acrylic paint can be added (e.g., to color a skin-like material or artificial skin), if desired. We used a mix of 0.4 g titanium white, 0.25 g Terre de Sienne and 0.25 g orange. It is noted that coloration with acrylic paint did change the product texture, but did not affect self healing and slightly increased elasticity of the material.

DESMO was then added dropwise over 5 min, with stirring continued for 10 min. The mix was then heated at 50° C. until the product became white and the stirrer started to jam. The product was then cast in a Teflon mold and left overnight under a fume hood to remove residual DCM. Finally a hot press was used at 90° C. to shape the product into a film, by pressing 3-times, and breaking apart to remove air from the product and provide a uniform film.

A general procedure for bulk (minimal solvent or solvent-free) synthesis was also used, as follows: All amino and hydroxyl compounds plus catalyst (where applicable) were mixed thoroughly. Separately, NCO-compounds were mixed as well, and then quickly combined at rigorous mixing/stirring. Some heating was applied until exotherm started to evolve and the mixture was then placed in a preheated 90° C. oven for 1-18 hours (h), until completely cured.

### Example 2

### Preparation of Low-Temperature Thermal Self-Healing PDMS-Based Materials (Polyurethane/Urea)

The procedure was similar to the one described in Example 1 for SH26 (solvent-assisted) and for bulk synthesis, respectively.

Thermo-healing elastomeric material (SH26, MK-323) were prepared. The compositions are shown in Table 2.

TABLE 2
PDMS-2NH₂/HMDI/HEDS/DESMO N3300/1,3-Propanediol bis-(4-aminobenzoate)
self-healing elastomeric materials (MK-323).

| | | | | | 1,3-Propanediol | | |
|---|---|---|---|---|---|---|---|
| | PDMS- | | | | bis-(4- | | |
| | 2NH₂ | HEDS | HMDI | DESMO | aminobenzoate) | | |
| | (av. 3000) | (154) | (168) | (av. 577*) | (314) | | |
| | g/mmol NH₂ | g/mmol OH | g/mmol NCO | g/mmol NCO | g/mmol NH₂ | DBTDA | Solvent |
| SH26¹ | 10/6.67 | 0.642/8.34 | 1.079/12.85 | 0.284/1.48 | — | 300 μL | DCM |
| | | | | | | | (40 mL) |
| 323A | 1.65/1.1 | 0.13/1.7 | 0.30/3.6 | 0.088/0.45 | — | 10 μL | — |
| 323B | 1.70/1.13 | 0.13/1.7 | 0.30/3.6 | 0.058/0.30 | — | 10 μL | MEK |
| | | | | | | | (0.2 mL) |
| 323C | 2.00/1.33 | 0.13/1.7 | 0.16/1.9 | 0.040/0.21 | — | 10 μL | MEK |
| | | | | | | | (0.2 mL) |
| 323D¹ | 2.00/1.33 | — | 0.16/1.9 | 0.040/0.21 | 0.27 | — | MEK |
| | | | | | 1.7 | | (0.2 mL) |
| 323E¹ | 2.00/1.33 | — | 0.16/1.9 | 0.040/0.21 | 0.27 | — | MEK |
| | | | | | 1.7 | | (0.2 mL) |
| | | | | | | | DCM |
| | | | | | | | (0.5 mL) |

*based on CoA
¹possesses thermal and/or intrinsic self-healing properties

### Example 3

### Preparation of Low-Temperature Thermal Self-Healing PPO-Based Materials (Polyurethane and Poly[Urethane/Urea])

The procedure was similar to the one described in Example 1 for SH26 (solvent-assisted) and for bulk synthesis, respectively.

Thermo-healing elastomeric materials (MK-326) were prepared. The compositions are shown in Table 3.

TABLE 3
PPO-2NCO/PPO-2OH/HMDI/IPDI/Triethanolamine/1,3-Propanediol
bis-(4-aminobenzoate)/4,4′-Dithiodianiline/NCC
self-healing elastomeric materials (MK-326).

| | SH47NCC¹ | 326-1 | 326-2 | 326-3 | 326-4 | 326-5¹ | 326-6 |
|---|---|---|---|---|---|---|---|
| PPO-2NH₂ (av. | 3.96/1.98 | 4.0/2.0 | 4.0/2.0 | | | | |
| 4000); | | | | | | | |
| g/mmol NH₂ | | | | | | | |
| PPO-2OH (av. | | | | 4.33/2.16 | | 4.12/2.06 | |
| 4000); | | | | | | | |
| g/mmol OH | | | | | | | |
| PPO-2NCO (av. | 4.55/3.96 | 4.5/3.9 | 4.5/3.9 | 4.78/4.15 | 7.8/6.8 | 4.85/4.22 | 4.4/3.83 |
| 2300); | | | | | | | |
| g/mmol NCO | | | | | | | |
| HMDI (168); | 0.33/3.93 | | 0.32/3.9 | 0.39/4.64 | | 0.36/4.30 | |
| g/mmol NCO | | | | | | | |
| IPDI (222); | | 0.07/0.62 | | | | | |
| g/mmol NCO | | | | | | | |
| 4,4′-Dithiodianiline | 0.41/3.31 | | | | | 0.5/4.0 | |
| (248); | | | | | | | |
| g/mmol NH₂ | | | | | | | |
| 1,3-Propanediol | | | | 0.6/3.8 | | | |
| bis-(4- | | | | | | | |
| aminobenzoate) | | | | | | | |
| (314); | | | | | | | |
| g/mmol NH₂ | | | | | | | |
| Triethanolamine | 0.10/2.01 | 0.12/2.4 | 0.12/2.4 | 0.1/2.0 | 0.17/3.4 | 0.1/2.0 | 0.21/4.23 |
| (149); | | | | | | | |
| g/mmol OH | | | | | | | |
| NCC, g | 0.66 | 0.65 | 0.65 | 0.65 | | 0.65 | |
| DBTDA/DBTDL, | 200/— | 50/— | 50/— | 50/— | —/25 | —/50 | —/25 |
| μl | | | | | | | |
| Solvent, | DCM, 40 | | MEK, 1 | MEK, 1 | | MEK, 1 | |
| mL | | | | | | | |

¹possesses intrinsic self-healing properties

### Example 4

### Self-Healing PPO-Based Elastomeric Material (Polyurethane/Urea)

A self-healing PPO-based elastomeric material was prepared, as follows (mass/mass %):
39.57% PPO bis(2-amino propyl ether) (4000); 19.785 mmol —NH2;
0.98% triethanolamine (149); 19.73 mmol —OH;
45.5% PPO, tolylene 2,4-diisocyanate terminated (2300); 39.56 mmol —NCO
3.25% HMDI (168); 38.69 mmol —NCO;
6.595% NCC;
4.094% 4,4′-Dithiodianiline (248); 33.02 mmol —NH₂;
catalyst: DBTDA.

The material was prepared using procedures described above.

In some such embodiments, without wishing to be limited by theory, it is believed the association of a urea or urethane bond (H-bond group) with a highly mobile chain (PPO) and NCC to provide backbone structure are key to providing a self-healing elastomer (without NCC, in this case the system was a sticky, flowy gum). Self-healing properties may arise from two attributes: reversible bonds at room temperature (H-bonds and disulfide bonds), coupled with flexibility of the bulk of the material, structured around a rigid backbone (PPO linked to NCC), which provides a self-interpenetrating material over time (limited chain migration).

Dithiodianiline was found to have a positive impact on self-healing. Due to aromatic sulfure metathesis, this provided a dynamic bond able to break and form back at room temperature. Dithiodianiline can be replaced by a linear sulfide without major reduction in self-healing properties.

Triethanolamine is believed to provide cross-linking points, which allowed the material to behave as an elastomer.

### Example 5

### Preparation of Low-Temperature Thermal Self-Healing PDMS-Based Materials (Polyurethane or Polyurethane/Urea)

The procedure was similar to the one described in Example 1 for SH47 (solvent-assisted) and for bulk synthesis, respectively.

Thermo-healing elastomeric materials (MK-332) were prepared. The compositions are shown in Table 4.

TABLE 4
PDMS-2NH₂/MDI/IPDI/PDMS-2OH/HMDI self-healing elastomeric materials (MK-332).

| | PDMS- | PDMS- | | | | | | |
|---|---|---|---|---|---|---|---|---|
| | 2NH₂ | 2OH | MDI | IPDI | HMDI | | | |
| | (av. 3000) | (av. 5600) | (250) | (222) | (168) | DBTDL, | Solvent, | |
| | g/mmol NH₂ | g/mmol OH | g/mmol NCO | g/mmol NCO | g/mmol NCO | μL | mL | Notes |
| 332A | 5.8/3.87 | | 0.16/1.28 | 0.21/1.89 | 0.105/1.25 | | | Not intrinsically |
| | | | | | | | | self-healing |
| 332B | 5.0/3.33 | | 0.16/1.28 | 0.215/1.98 | | | MEK, 1 | US 20190106544; |
| | | | | | | | | PDMS-MPU_{0.4}- |
| | | | | | | | | IU_{0.6}; |
| | | | | | | | | Not intrinsically |
| | | | | | | | | self-healing |
| 332D | | 5.2/1.86 | 0.106/0.88 | 0.133/1.20 | | 15 | | Non-solid |

Although this invention is described in detail with reference to embodiments thereof, these embodiments are offered to illustrate but not to limit the invention. It is possible to make other embodiments that employ the principles of the invention and that fall within its spirit and scope as defined by the claims appended hereto.

The contents of all documents and references cited herein are hereby incorporated by reference in their entirety.

What is claimed is:

1. A self-healing elastomeric material comprising polysiloxane or polyether soft segments or a combination thereof, connected via carbonate, urethane and/or urea bonds, wherein the self-healing elastomeric material is intrinsically and/or thermally self-healing.

2. The elastomeric material of claim 1, wherein the elastomeric material comprises about 80 wt % of PPO or about 80 wt % of a polysiloxane derivative, optionally wherein the polysiloxane derivative is polydimethylsiloxane (PDMS).

3-4. (canceled)

5. The elastomeric material of claim 1, wherein the material is thermally self-healing, and comprises thermoreversible disulphide bonds.

6. (canceled)

7. The elastomeric material of claim 1, further comprising short hard segments formed by one or more of triethanolamine, 4,4′-dithiodianiline,a linear sulfide, 2-Hydroxyethyl disulfide (HEDS), 1,3-Propanediol bis-(4-aminobenzoate), hexamethylene diisocyanate (HMDI), isophorone diisocyanate (IPDI), HMDI oligomers (type urethdione and isocyanurate), methylene bis-diphenyldiisocyanate (MDI), dodecahydro methylene bis-diphenyldiisocyanate (MDI-H), bis-(isocyanato methylethylbenzene), and toluene diisocyanate (TDI).

8. (canceled)

9. The elastomeric material of claim 1, wherein the material is self-healable due to thermoreversible disulphide bonds and/or hydrogen bonds.

10. The elastomeric material of claim 1, wherein the elastomeric material is capable of self-healing at low to moderate temperature, at about 40° C. to about about 80° C., at less than about 80° C., or at room temperature.

11. The elastomeric material of claim 1, wherein the elastomeric material is incorporated into an artificial skin that has one or more of the following performance characteristics: instrinsic self-healing; thermal self-healing; tough;
stretchable; transparent; high-fidelity; self-healing without requiring liquid such as water, sweat or solvent; self-healing through chemical interactions (hydrogen bonding and/or thermoreversible disulfide bond re-formation or metathesis); realistic properties of human skin;
substantially the same or similar tensile strength, elongation at break point, extension ratio, elasticity, Young's modulus, fracture strain and/or shape recovery ability as human skin.

12. The elastomeric material of claim 1, wherein the elastomeric material is in the form of a film.

13. (canceled)

14. A high-fidelity skin-simulating layer comprising:
an epidermis-simulating layer, wherein the epidermis simulating layer comprises the elastomeric material of claim 1;
an upper dermis-simulating layer disposed upon and adjacent to the epidermis-simulating layer, wherein the upper dermis-simulating layer comprises the composite of elastomeric material of claim 1 and a silicone rubber and/or a polysiloxane softener;
a lower dermis-simulating layer disposed upon and adjacent to the upper dermis-simulating layer, wherein the lower dermis-simulating layer comprises a plurality of layers of the composite of elastomeric material of claim 1 and a polyamide mesh; and
a subcutaneous-simulating layer disposed upon and adjacent to the lower dermis-simulating layer, wherein the subcutaneous-simulating layer comprises a mixture of the composite of elastomeric material of claim 1 and/or a polysiloxane derivative and/or a polysiloxane softener.

15. The high-fidelity skin-simulating layer of claim 14, shaped to form at least one body part.

16. The high-fidelity skin-simulating layer of claim 14, further comprising a skeleton-simulating structure, the high-fidelity skin simulating layer being disposed upon the skeleton-simulation structure, and the skeleton-simulating structure being shaped to simulate at least one human body part.

17. The high-fidelity skin-simulating layer of claim 14, further comprising a muscle-simulating layer, wherein the high fidelity skin-simulating layer is disposed upon and adjacent to the muscle-simulating layer.

18. The high-fidelity skin-simulating layer of claim 14, incorporated into a three-dimensional surgical training model shaped to simulate at least one human body part, optionally wherein the at least one human body part comprises at least one of a human skull, a human neck, human shoulders, human ears, a human nose, or a human mouth.

19. (canceled)

20. The high-fidelity skin-simulating layer of claim 14, wherein the high fidelity skin-simulating layer comprises a tensile strength of from about 16 MPa to about 20 MPa, an elongation at break point of from about 65% to about 75%, and a durometer hardness of from about 4 to about 6.

21-22. (canceled)

23. The high-fidelity skin-simulating layer of claim 14, wherein the epidermis-simulating layer has a thickness of from about 0.5 mm to about 1.0 mm, a tensile strength of from about 1 MPa to about 3.4 MPa, and an elongation at break point of from about 700% to about 1100%.

24. The high-fidelity skin-simulating layer of claim 14, further comprising cutaneous defect-simulating structures disposed therein, wherein the cutaneous defect-simulating structures are selected from the group consisting of lesions, wounds, cysts, lymphomas, scars and combinations thereof, and wherein at least one of the cutaneous defect simulating structures protrudes above an outer-most surface of the epidermis-simulating layer.

25. (canceled)

26. The high-fidelity skin-simulating layer of claim 14, wherein the lower dermis-simulating layer comprises a thickness of about 1.0 mm to about 1.5 mm; and the lower dermis-simulating layer comprises at least one blood vessel-simulating structure embedded therein such that synthetic blood may be injected into the at least one blood vessel-simulating structure to simulate bleeding upon demonstrating or practicing surgical techniques thereon.

27. (canceled)

28. The high-fidelity skin-simulating layer of claim 26, wherein the at least one blood vessel-simulating structure comprises the self-healing elastomeric material of any one of the preceding claims, such that it can bleed when cut and then self-heal to stop the bleeding.

29. (canceled)

30. A method of training medical practitioners comprising performing or demonstrating a surgical technique upon the high-fidelity skin-simulating layer of claim 14.

31. (canceled)

32. A device or apparatus comprising the elastomeric material of claim 1, wherein the device or apparatus is a wearable item, an electronic device, a medical training simulator, a mannequin, a suture pad in an electric heated box, a reversible bleeding and healing skin, a surgical simulator for training for cardiac or intestinal anastomosis, an orthopedic surgical model for training in tendon or ligament repair, or a realistic healing brain model for training in neurosurgery.

33-35. (canceled)
